(19) United States
(12) Patent Application Publication
(10) Pub. No.: US 2025/0292313 A1
(43) Pub. Date: Sep. 18, 2025

(54) VIRTUAL POINT-OF-SALE SYSTEM FOR THE METAVERSE

(71) Applicant: Capital One Services, LLC, McLean, VA (US)

(72) Inventors: Samuel RAPOWITZ, Roswell, GA (US); Kevin OSBORN, Newton Highlands, MA (US); Mia RODRIGUEZ, Broomfield, CO (US); Kathryn TIKOIAN, South Orange, NJ (US)

(73) Assignee: Capital One Services, LLC, McLean, VA (US)

(21) Appl. No.: 18/605,529

(22) Filed: Mar. 14, 2024

(51) Int. Cl. G06Q 30/0601; G06F 3/01; G06Q 20/12; G06Q 20/20; G06Q 20/40

(52) U.S. Cl. CPC G06Q 30/0643; G06F 3/017; G06Q 20/123; G06Q 20/20; G06Q 20/40145

(57) ABSTRACT

A method, a system, and a computer program product for execution of transactions using virtual computing systems. A request to execute a virtual transaction with a virtual computing device communicating in a virtual computing system is received. The virtual transaction is requested by a user using a user device communicating with the virtual computing system. In response to receiving the request to execute the transaction, the user is authenticated in the virtual computing system. Authentication includes receiving, by the virtual computing device, a user authentication data representing the user and comparing the received user authentication data with stored user authentication data. Upon determining a match between the received and stored authentication data, the user is authenticated in the virtual computing system and the virtual transaction is executed using the virtual computing device. Execution of the transaction is prevented if there is no match between the received and stored authentication data.

### TECHNICAL FIELD

This disclosure relates generally to data processing and, in particular, to virtual transaction systems in a metaverse, and more particularly, to execution of various transactions using virtual computing systems.

### BACKGROUND

Virtual reality, augmented reality, mixed reality or extended reality (XR) computing systems provide their users with an ability to experience simulated environments. Such experiences may be accomplished through use of various devices, such as, for example, pose tracking, three-dimensional near-eye displays (e.g., virtual reality glasses, etc.), which enable users to have an immersive feel when existing in a virtual world. Some applications of the virtual reality, augmented reality, etc. are prevalent in video games, education, medical and/or military training, virtual business meetings, etc. However, existing virtual reality, augmented reality, etc. systems are not capable of providing authentication mechanisms to authenticate users for the purposes of performing various transactions.

### SUMMARY

In some implementations, the current subject matter relates to a computer-implemented method for execution of transactions using virtual computing systems. The method may include receiving, using at least one processor, a request to execute a virtual transaction with a virtual computing device communicating in a virtual computing system. The virtual transaction may be requested by a user using a user device communicating with the virtual computing system. The method may also include authenticating, in response to receiving the request to execute the virtual transaction, the user in the virtual computing system. Authentication may include receiving, by the virtual computing device, in response to a request from the virtual computing system, a user virtual authentication data representing the user. The user virtual authentication data may be generated by the user device and transmitted to the virtual computing system. Authentication may also include comparing the received user virtual authentication data with at least one stored user authentication data. The stored user authentication data may be stored in a storage location communicatively coupled to the virtual computing system. Upon determining a match between the received user virtual authentication data and the stored user authentication data, the user may be authenticated in the virtual computing system and the virtual transaction may be executed using the virtual computing device. Upon failing to determine a match between the received user virtual authentication data and the stored user authentication data, execution of the virtual transaction using the virtual computing device may be prevented.

In some implementations, the current subject matter relates to a system for execution of transactions using virtual computing systems. The system may include at least one processor, and at least one non-transitory storage media storing instructions, that when executed by the processor, cause the processor to perform operations that may include receiving, by a virtual computing device, a user virtual authentication data representing a user. The user may use a user device to communicate with a virtual computing system including the virtual computing device and to transmit a request to execute a virtual transaction associated with at least one virtual object in the virtual computing system. The user virtual authentication data may be generated by the user device and transmitted to the virtual computing system. The operations may also include comparing the received user virtual authentication data with at least one stored user authentication data. The stored user authentication data may be stored in a storage location communicatively coupled to the virtual computing system. Upon determining a match between the received user virtual authentication data and the stored user authentication data, the user may be authenticated in the virtual computing system and the virtual transaction may be executed using the virtual computing device. Upon failing to determine a match between the received user virtual authentication data and the stored user authentication data, execution of the virtual transaction using the virtual computing device may be prevented.

In some implementations, the current subject matter relates to a computer program product for execution of transactions using virtual computing systems, where the computer program product may include a non-transitory machine-readable medium storing instructions that, when executed by at least one programmable processor, cause the programmable processor to perform operations that may include receiving, by a virtual computing device, a user virtual authentication data representing a user. The user using a user device, communicating with a virtual computing system including the virtual computing device, may transmit a request to execute a virtual transaction associated with at least one virtual object in the virtual computing system. The user virtual authentication data may be generated by the user device and transmitted to the virtual computing system. The operations may also include executing an authentication of the user by comparing the received user virtual authentication data with at least one stored user authentication data. The stored user authentication data may be stored in a storage location communicatively coupled to the virtual computing system. The operations may further include executing, based on the executing of the authentication, the virtual transaction using the virtual computing device. Executing of the virtual transaction may include transmitting, by the virtual computing system, a request to execute the virtual transaction to at least one server communicatively coupled to the virtual computing system. The server may store data associated with the virtual object and identified with the virtual computing device. Execution of the transaction may also include receiving, by the virtual computing system, from the server, an authorization to procure the virtual object upon determining that the user has been authenticated.

In some implementations, the current subject matter may include one or more of the following optional features. The virtual computing device may include at least one of the following: a virtual point-of-sale terminal, a virtual gaming terminal, and any combination thereof. The virtual transaction may include at least one of the following: a virtual purchase transaction, a virtual gaming transaction, and any combination thereof. The virtual authentication data may be generated by the user device based on at least one personal identification data. The personal identification data may include at least one of the following: data associated with the user, data generated by the user device based on the data associated with the user, data generated by the user device based on at least one action performed by the user, data generated by the user device based on at least one action performed by the user device, and any combination thereof. In some implementations, the personal identification data may include at least one of the following: at least one gesture performed by the user, at least one movement performed by the user, at least one biometric data associated with the user, and any combination thereof.

In some implementations, the virtual transaction may be associated with at least one virtual object existing in the virtual computing system. The request to execute the virtual transaction may include procuring the virtual object. Procuring of the virtual object may include: transmitting, by the virtual computing system, the request to execute the virtual transaction to at least one server communicatively coupled to the virtual computing system. The server may store data associated with the virtual object and identified with the virtual computing device. Procuring may also include performing, by the virtual computing system, the authenticating of the user, and transmitting a result of the authenticating to the server, where the result may include a determination whether the user has been authenticated, and receiving, by the virtual computing system, from the server, an authorization to procure the virtual object upon determining that the user has been authenticated. Upon procuring of the virtual object, the server may update the stored data associated with the virtual object to indicate that the virtual object is associated with the user and is no longer associated with the virtual computing device.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary virtual transaction execution environment, according to some implementations of the current subject matter;

FIG. 2 illustrates an exemplary process for execution of a transaction in a virtual computing system, according to some implementations of the current subject matter;

FIG. 3 illustrates an exemplary process for procuring one or more objects (as shown in FIG. 1), according to some implementations of the current subject matter;

FIG. 4 illustrates another exemplary process for execution of a transaction in the virtual computing environment shown in FIG. 1, according to some implementations of the current subject matter;

FIG. 5 illustrates another exemplary process for executing a transaction in a virtual computing environment (e.g., environment shown in FIG. 1), according to some implementations of the current subject matter; and

FIG. 6 illustrates an exemplary computer architecture, according to some implementations of the current subject matter.

### DETAILED DESCRIPTION

To address these and potentially other deficiencies of currently available solutions, one or more implementations of the current subject matter relate to methods, systems, articles of manufacture, and the like that can, among other possible advantages, provide virtual transaction systems in a metaverse, and more particularly, to execution of various transactions using virtual computing systems.

In some implementations, the current subject matter generally relates to a system for execution of virtual computing transactions using physical user devices (e.g., virtual reality glasses, etc.), such as, for example, virtual point-of-sale transactions for acquiring of virtual objects in a metaverse. The metaverse may be a network of three-dimensional (3D) environments and/or simulations that users may access and interact with various virtual computing objects, other users, etc. Some non-limiting examples of such interactions may involve execution of virtual transactions using virtual “storefronts”, which users may “enter” in a virtual reality and observe and interact with virtual representations of physical goods and/or strictly virtual goods. On a backend, the virtual storefronts may be represented by one or more physical computing devices (e.g., processors, servers, storage devices, etc.), networks of computing devices, cloud computing systems, and/or any other devices, networks, and/or systems.

The storefronts and/or any type of virtual devices may be configured to execute various virtual computing transactions, e.g., payments, purchases of real and/or virtual goods, manage and/or exchange various information, etc. One of the advantages of such virtual devices is their ability to authenticate users that may be interacting with the devices in the virtual computing system, where such devices are operating. In some implementations, the users may be authenticated through use of their virtual reality hardware devices. For example, the user may be asked to perform an action, such as, a movement of a head, a hand, and/or any other body part. Alternatively, or in addition, the user may be asked to provide one or more biometric data, such as, for example, an iris scan, a fingerprint, a palm print, etc. Such authentication data may be configured to be compared to stored authentication data, which in turn, may be mapped to user's account, which may include a virtual, cryptographic, and/or any other type of digital data (e.g., a cryptographic wallet that may include non-cryptographic wallet).

In further exemplary implementations, the user's movements (e.g., eye(s) movement(s), limb(s) movement(s), etc.) may be tracked by user's virtual reality hardware (e.g., virtual reality glasses, sensory gloves, etc.) and transposed into the virtual reality computing system. The transposed movement(s) may be authenticated in the virtual reality computing system using virtual reality devices with which the user may be interacting with.

In some example implementations, the current subject matter may relate to a virtual transaction system for execution of one or more transactions in a virtual reality computing environment (e.g., a metaverse). Any combination of hardware and/or software may be configured to execute various operations in the virtual reality computing environment.

The virtual reality computing environment may be configured to include one or more virtual computing devices that may be used for execution of one or more transactions (e.g., a purchase transaction, a data exchange transaction, a banking transaction, etc.) with the user. The transactions may be real and/or virtual and/or may involve real and/or virtual objects. To execute such transactions, the user may use one or more virtual reality devices (e.g., a virtual reality glasses, sensory glove(s), etc.) that may allow the user to interact with such one or more virtual computing devices. For instance, the user, using user's virtual reality devices, may enter the virtual computing environment and identify and/or locate one or more virtual computing devices for the purposes of execution of one or more transactions. The user may transmit, using the user's virtual reality device(s), a request to execute one or more transactions with the virtual computing device.

In order to proceed with the requested transaction(s), the virtual computing device may be configured to execute an authentication of the user requesting execution of the transaction. The authentication process may involve the virtual computing device requesting from the virtual computing environment a user virtual authentication data that may the user. The virtual computing environment may be configured to transmit such request to the user and prompt the user to perform one or more actions using the user's virtual reality device. For example, the user may be requested to perform a movement of the user's head, eyes, limbs, etc. Alternatively, or in addition, the user may be asked to provide biometric data, e.g., a fingerprint, an iris scan, a palm print, etc. The user may also be asked to provide a username and/or password. As can be understood, the user may be asked to provide any type of authentication credentials and/or information for verification purposes. Based on the provided information, the current subject matter may be configured to generate a user virtual authentication data and transmit such data to the virtual computing system.

The received user virtual authentication data may be compared with at least one stored user authentication data. Such stored user authentication data may be stored in one or more storage locations that may be communicatively coupled to the virtual computing environment. The stored user authentication data may be generated, for instance, as a result of prior transactions executed with the user, previous access to the virtual computing environment by the user, and/or in any other way.

Upon determining that a match between the user virtual authentication data that has been generated by the virtual reality device and provided to the virtual computing environment and the stored user authentication data, the user may be authenticated. Authentication may be performed for the purposes of executing the virtual transaction using the virtual computing device. Alternatively, or in addition, authentication may be performed for the purposes of allowing the user to access the virtual computing environment and executing any desired transactions.

However, if the generated user virtual authentication data does not match the stored user authentication data, the user may be prevented from execution of the virtual transaction using the virtual computing device. An error may be generated and/or displayed by the virtual computing environment. The user may also be prompted to perform the authentication process again by performing the requested movements, submission of authentication data, etc. Alternatively, or in addition, the current subject matter may be configured to request the user to perform other methods of authentication that may be different from the initial authentication method.

In some exemplary, non-limiting implementations, the virtual computing device that may be operating in the virtual computing environment may include at least one of the following: a virtual point-of-sale terminal, a virtual gaming terminal, and any combination thereof. Moreover, the virtual transactions that may be executed may include at least one of the following: a virtual purchase transaction, a virtual gaming transaction, and any combination thereof. As can be understood, any other types of virtual computing devices may be used for execution of any other types of virtual transactions.

In some implementations, the virtual authentication data that may be generated by the user's virtual reality device may be based on at least one personal identification data, which may include at least one of the following: data associated with the user (e.g., name, address, banking information, etc.), data generated by the user's virtual reality device based on the data associated with the user (e.g., virtual account numbers, avatars, virtual screennames, etc.), data generated by the user's virtual reality device based on at least one action performed by the user (e.g., an image data file corresponding an iris scan of the user's eye, an image data file corresponding to a fingerprint of the user, etc.), data generated by the user's virtual reality device based on at least one action performed by the user's virtual reality device, etc. As can be understood, any other virtual authentication data may be generated and/or used for the purposes of authenticating the user in the virtual computing environment. In some example implementations, the personal identification data may include at least one of the following: at least one gesture performed by the user, at least one movement performed by the user, at least one biometric data associated with the user, and any combination thereof.

In some example implementations, one or more virtual transactions that may be executed by the user may be configured to involve one or more virtual objects (e.g., a good, a service, a data, etc.) and/or one or more real objects. For instance, as part of executing of the virtual transaction, the user may wish to procure one or more such virtual and/or real objects. To procure objects, the virtual computing environment may be configured to transmit the request to execute the virtual transaction to one or more server (e.g., a cloud server, etc.) communicatively coupled to the virtual computing environment. The server may be configured to store data associated with the requested and/or identified object (virtual and/or real). The data may include an identification of the object (e.g., ObjectID), a description of the object, etc. Upon receiving a request for the object, the server may also execute authentication of the user based on a prior authentication of the user by the virtual computing environment. The server may then transmit an authorization to procure the identified object upon a determination that the user has been authenticated. Further, procurement of the object may result in updating, at server, data that may be associated with the virtual object and stored at the server, to indicate that the object is now associated with the user and is no longer associated with the virtual computing device. For example, an object has been sold to the user upon receiving an appropriate payment from the user (e.g., in virtual currency).

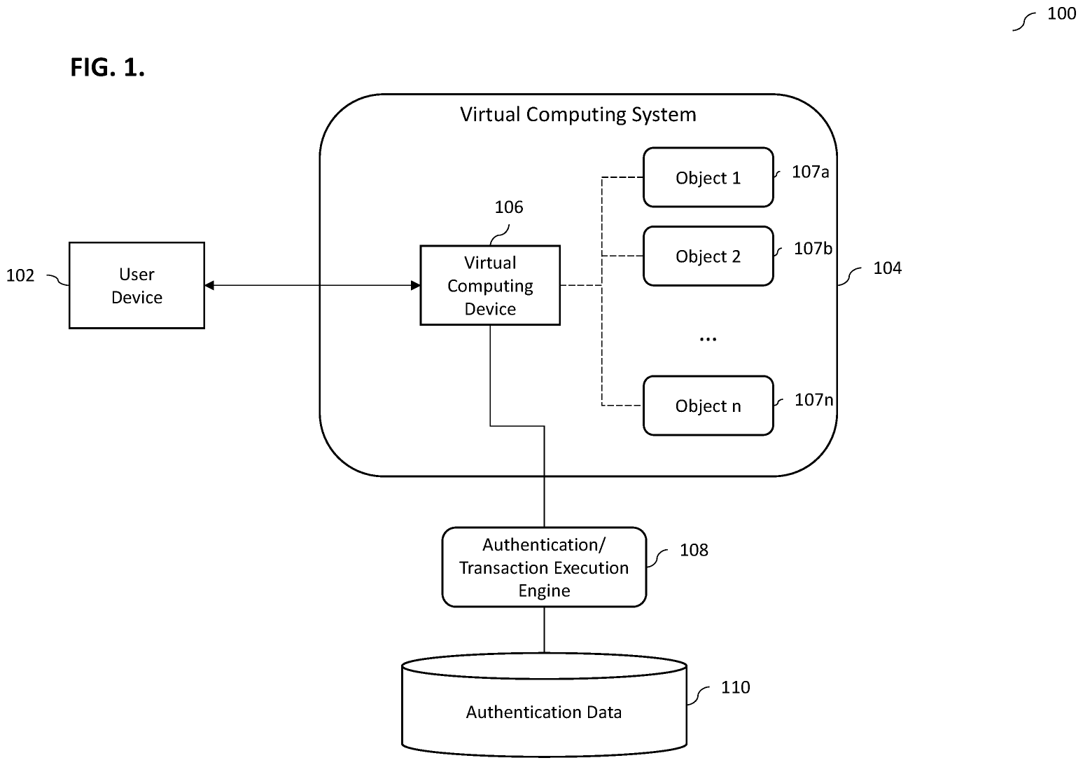

FIG. 1 illustrates an exemplary virtual transaction execution environment 100, according to some implementations of the current subject matter. The environment 100 may include one or more user devices 102 (e.g., virtual reality device, such as, for example, virtual reality glasses, sensory glove(s), etc.), a virtual computing system 104 that may include one or more virtual computing device(s) 106 (e.g., a virtual point-of-sale terminal, a virtual gaming terminal, etc.), one or more authentication/transaction execution engines 108, and one or more storage locations 110 that may be configured to store user authentication data. The components 102-110 may be communicatively coupled using one or more communications networks. The communications networks may include one or more of the following: a wired network, a wireless network, a metropolitan area network (“MAN”), a local area network (“LAN”), a wide area network (“WAN”), a virtual local area network (“VLAN”), an internet, an extranet, an intranet, and/or any other type of network and/or any combination thereof.

Further, components 102-110 may include any combination of hardware and/or software. In some implementations, components 102-110 may be disposed on one or more computing devices, such as, server(s), database(s), personal computer(s), laptop(s), cellular telephone(s), smartphone(s), tablet computer(s), virtual reality devices, and/or any other computing devices and/or any combination thereof. In some example implementations, components 102-110 may be disposed on a single computing device and/or may be part of a single communications network. Alternatively, or in addition to, such services may be separately located from one another. A service may be a computing processor, a memory, a software functionality, a routine, a procedure, a call, and/or any combination thereof that may be configured to execute a particular function associated with the current subject matter lifecycle orchestration service(s).

In some implementations, the environment 100′s components, including one or more components 102-110, may include network-enabled computers. As referred to herein, a network-enabled computer may include, but is not limited to a computer device, or communications device including, e.g., a server, a network appliance, a personal computer, a workstation, a phone, a smartphone, a handheld PC, a personal digital assistant, a thin client, a fat client, an Internet browser, or other device. The components of the environment 100 also may be mobile computing devices, for example, an iPhone, iPod, iPad from Apple® and/or any other suitable device running Apple's iOS® operating system, any device running Microsoft's Windows®. Mobile operating system, any device running Google's Android® operating system, and/or any other suitable mobile computing device, such as a smartphone, a tablet, or like wearable mobile device.

The components of the environment 100 may include a processor and a memory, and it is understood that the processing circuitry may contain additional components, including processors, memories, error and parity/CRC checkers, data encoders, anti-collision algorithms, controllers, command decoders, security primitives and tamper-proofing hardware, as necessary to perform the functions described herein. The components of the environment 100 may further include one or more displays and/or one or more input devices. The displays may be any type of devices for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some example implementations, the components of the environment 100 may execute one or more applications, such as software applications, that enable, for example, network communications with one or more components of environment 100 and transmit and/or receive data.

The components of the environment 100 may include and/or be in communication with one or more servers via one or more networks and may operate as a respective front-end to back- end pair with one or more servers. The components of the environment 100 may transmit, for example from a mobile device application (e.g., executing on one or more user devices, components, etc.), one or more requests to one or more servers (e.g., server(s) 108). The requests may be associated with retrieving data from servers. The servers may receive the requests from the components of the environment 100. Based on the requests, servers may be configured to retrieve the requested data from one or more databases (e.g., storage 110 as shown in FIG. 1). Based on receipt of the requested data from the databases, the servers may be configured to transmit the received data to one or more components of the environment 100, where the received data may be responsive to one or more requests.

The environment 100 may include one or more networks. In some examples, networks may be one or more of a wireless network, a wired network or any combination of wireless network and wired network and may be configured to connect the components of the environment 100 and/or the components of the environment 100 to one or more servers. For example, the networks may include one or more of a fiber optics network, a passive optical network, a cable network, an Internet network, a satellite network, a wireless local area network (LAN), a metropolitan area network (MAN), a wide area network (WAN), a virtual local area network (VLAN), an extranet, an intranet, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or any other type of network and/or any combination thereof.

In addition, the networks may include, without limitation, telephone lines, fiber optics, IEEE Ethernet 802.3, a wide area network, a wireless personal area network, a LAN, or a global network such as the Internet. Further, the networks may support an Internet network, a wireless communication network, a cellular network, or the like, or any combination thereof. The networks may further include one network, or any number of the exemplary types of networks mentioned above, operating as a stand-alone network or in cooperation with each other. The networks may utilize one or more protocols of one or more network elements to which they are communicatively coupled. The networks may translate to or from other protocols to one or more protocols of network devices. The networks may include a plurality of interconnected networks, such as, for example, the Internet, a service provider's network, a cable television network, corporate networks, such as credit card association networks, and home networks.

The environment 100 may include one or more servers, which may include one or more processors that maybe coupled to memory. Servers may be configured as a central system, server or platform to control and call various data at different times to execute a plurality of workflow actions. Servers may be configured to connect to the one or more databases. Servers may be incorporated into and/or communicatively coupled to at least one the components of the environment 100.

One or more components 102-110 may be configured to execute one or more transactions using one or more containers. In some implementations, each transaction may be executed using its own container. A container may refer to a standard unit of software that may be configured to include the code that may be needed to execute the action along with all its dependencies. This may allow execution of actions to run quickly and reliably.

To execute a transaction (e.g., a virtual and/or a real, such as, a virtual purchase transaction, a virtual gaming transaction, etc.), such as a transaction to procure an object (e.g., a virtual and/or a real object), the user may use one or more user devices 102 to communicate with the virtual computing device 106 operating in the virtual computing system 104. One or more objects 1, 2, . . . n 107 (a, b, . . . , n) may be configured to be associated with the virtual computing device 106 and may be available for procurement. For example, the virtual computing device 106 may be a point-of-sale terminal and may be configured to offer for sale one or more objects 107. Alternatively, or in addition, the objects 107 may be real objects (e.g., watches, etc.) that the user, using user device 102, may procure via execution of a transaction with the virtual computing device 106. The objects 107 may also be virtual objects, e.g., gaming tokens that the user may purchase for playing a video game in the virtual computing system 104 and/or any other system.

In order to initiate a transaction with the virtual computing device 106, the user, using the device 102, may access the virtual computing system 104, such as, for example, by providing user credentials (e.g., entering a username and/or password, using a face authentication, a fingerprint authentication, etc.). Alternatively, or in addition, the virtual computing system 104 may be configured to transmit a request to the user device 102 to authenticate the user. For example, the user may be asked to perform a particular action (e.g., a movement of a head, a limb, etc.), provide biometric information (e.g., an iris scan, a fingerprint, a palm print, etc.), and/or provide any other form of information to verify user's identity. The information provided by the user, using the user device 102, may be referred to as a user authentication data and/or virtual user authentication data.

In some implementations, the user authentication data may be stored in the storage location 110 for future use, such as, for example, during a next time, when the user accesses the virtual computing system 104. To ensure authenticity of the stored user authentication data, the data may be verified prior to storage. The stored user authentication data may also be encrypted with one or more encryption keys to prevent tampering with the data.

Upon accessing the virtual computing system 104 and initiating an interaction with the virtual computing device 106, the user, using the user device 102, may be configured to browse objects 107 that may be available from the virtual computing device 106 for procurement. The user may then select a particular object 107 (e.g., object 1 107a) and indicate the user's desire to procure it. For example, the user may use the user device 102 to point and tap on the desired object in the virtual computing system 104 indicating the user's desire to acquire it.

The virtual computing device 106 may be configured to receive user's selection of the object 107 and execute an authentication process to verify user's identity prior to allowing the user to procure the selected object. The virtual computing device 106 may be configured to transmit a request to the user device 102 to provide user authentication data (e.g., head movement, limb movement, biometric data (e.g., iris scan, face scan, fingerprint, palm print, etc.).

The request from the virtual computing device 106 may be presented on a user interface of the user device 102. The user may then comply with the request and generate the requested user authentication data (e.g., head movement, limb movement, biometric data (e.g., iris scan, face scan, fingerprint, palm print, etc.). The generated user authentication data may be transmitted, by the user device 102, to the virtual computing device 106.

Then, the virtual computing device 106 may be configured to transmit the received user authentication data to the engine 108 and request its authentication. In response, the engine 108 may generate a query to the storage location 110 to retrieve stored user authentication data. Upon receipt of the stored user authentication data, the engine 108 may be configured to perform decryption of the stored user authentication data, if necessary. The engine 108 may then execute a comparison of the user authentication data received from the virtual computing device 106 and the stored user authentication data.

If a match between the received user authentication data and the stored user authentication data is determined, the engine 108 may be configured to verify the received user authentication data and authenticate the user in the virtual computing system 104. Moreover, the engine 108 may be configured to execute the transaction for procuring the object 107 selected by the user. For example, the engine 108 may be configured to access a digital wallet that may be associated with the user and provide appropriate renumeration to the virtual computing device 106 in exchange for procuring the selected object 107 and providing it to the user. Once procured, the virtual computing system 104 may be configured to change a status associated with the object 107 as being associated with the user, rather than the virtual computing device 106.

However, if the engine 108 fails to determine a match between the received user virtual authentication data and the stored user authentication data, the engine 108 may be configured to indicate to the virtual computing device 106 that no match has been detected. The engine 108 may also prevent execution of the virtual transaction using the virtual computing device 106, thereby preventing the user from procuring the selected object 107. In some implementations, the virtual computing device 106 may be configured to request the user to repeat the authentication process and/or provide alternate form of user authentication data. For example, if on a first attempt of authentication, the user provided a fingerprint, the virtual computing device 106 may be configured to request the user to provide an iris scan and/or any other information.

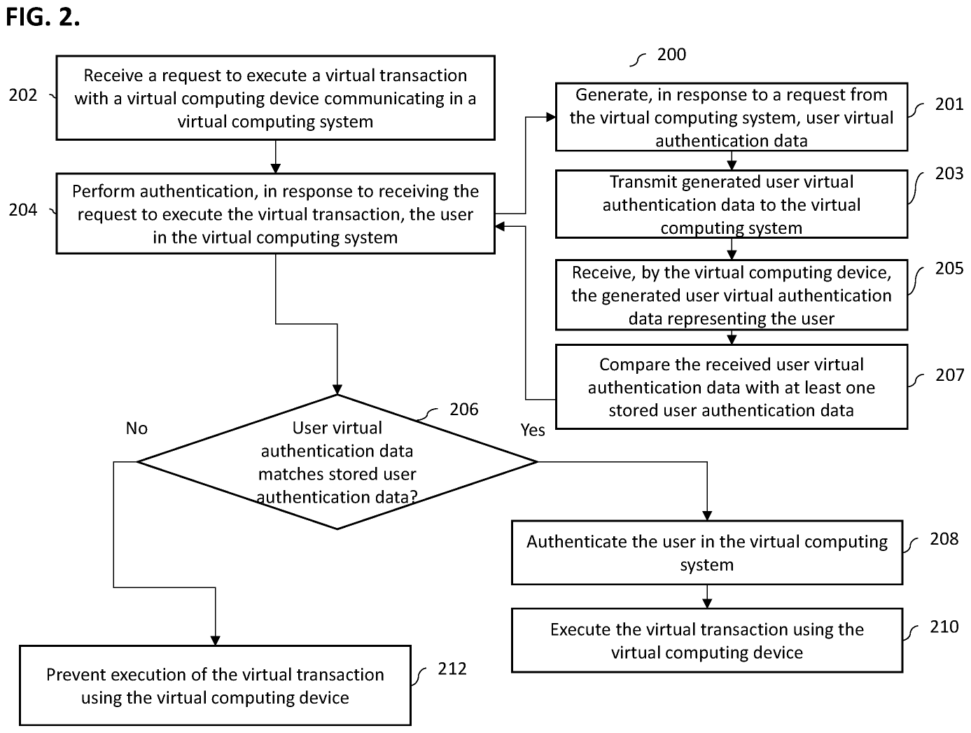

FIG. 2 illustrates an exemplary process 200 for execution of a transaction in a virtual computing system, according to some implementations of the current subject matter. The process 200 may be configured to be executed by one or more components 100, including, but not limited to, the user device 102, the virtual computing system 104, the engine 108 and/or the storage location 110, as shown in FIG. 1.

At 202, a request to execute a virtual transaction with the virtual computing device 106 of the virtual computing system and/or environment 104 may be transmitted by the user device 102 and received by the virtual computing system 104, and in particular, the virtual computing device 106. As stated above, the virtual transaction may be requested by the user using the user device 102 that may be configured to be communicatively coupled to the virtual computing system 104. Using the user device 102 (e.g., virtual reality glasses, sensory gloves, etc.), the user may be able to navigate a virtual reality environment that may be created by the virtual computing system 104. In the virtual reality environment, the user may be able to interact with virtual computing device(s) 106 and/or any other objects. The user may also procure objects, play games, execute various transactions, perform banking operations, and/or any other actions.

The virtual reality environment may include any type of virtual reality (VR), augmented reality (AR), mixed reality (or extended reality (XR)), etc. The user may access such virtual reality environment using any desired hardware devices, such as, for example, virtual reality headsets and/or multi-projected computing devices that may be configured to generate realistic images, sounds, and/or any other sensations that may be configured to simulate user's physical presence in the virtual reality environment. The user, using the virtual reality equipment, may be configured to “look” around, move around, and interact with virtual objects in the artificial world. Virtual reality environment may include audio and/or video feedback as well as any other type of sensory and/or force feedback, such as, for example, through haptic technology.

At 204, the virtual computing system 104 may be configured to perform/execute an authentication of the user. The authentication process may be triggered in response to receiving the user's request to execute a virtual transaction involving one or more objects 107.

The authentication process may involve one or more of the following operations. At 201, the user device 102 may be configured to receive from the virtual computing system 104 a request to generate a user virtual authentication data that may represent the user. In some example implementations, the request may be transmitted by the virtual computing device 106 with which the user may have been interacting for the purposes of executing a transactions involving one or more objects 107. The user may be requested to perform a particular action (e.g., perform at least one gesture and/or at least one movement, provide at least one biometric data associated with the user, etc.). The performed action may be configured to generate various data that may, in turn, be used to generate user authentication data and/or user virtual authentication data. The generated user authentication data may be transmitted by the user device 102 to the virtual computing system 104, at 203.

In some implementations, the generated user authentication data may be generated based on and/or using user's personal identification data. Such user's personal identification data may include data associated with the user (e.g., name, address, username, password, etc.). As stated above, the data may also include data generated by the user device 102 based on the data associated with the user (e.g., an encrypted data file containing user's name, address, username, password, etc.). Further, the data generated by the user device based on at least one action performed by the user and/or user device (e.g., data resulting from an iris scan of the user's eye(s), data resulting from a face scan of the user, etc.). As can be understood, any other type of personal identification data may be used and/or any other type of user authentication data may be generated and provided to the virtual computing device 106 for the purposes of authentication.

At 205, the virtual computing device 106 may be configured to receive the generated user authentication data and compare the received user authentication data with at least one stored user authentication data, at 207. The stored user authentication data may be stored in the storage location 110 that may be communicatively coupled to the virtual computing system 104, as shown in FIG. 1. For authentication purposes, the virtual computing device 106 may be configured to forward the received user authentication data, as generated by the user device 102, to the server 107 (as shown in FIG. 1), which may, in turn, query stored user authentication data from the storage location 110. The server 108 may be configured to execute the comparison of the received user authentication data and the stored user authentication data, at 207. Alternatively, or in addition, the virtual computing device 106 may be configured to execute the comparison of the received user authentication data and the stored user authentication data and/or perform one or more operations associated with authentication.

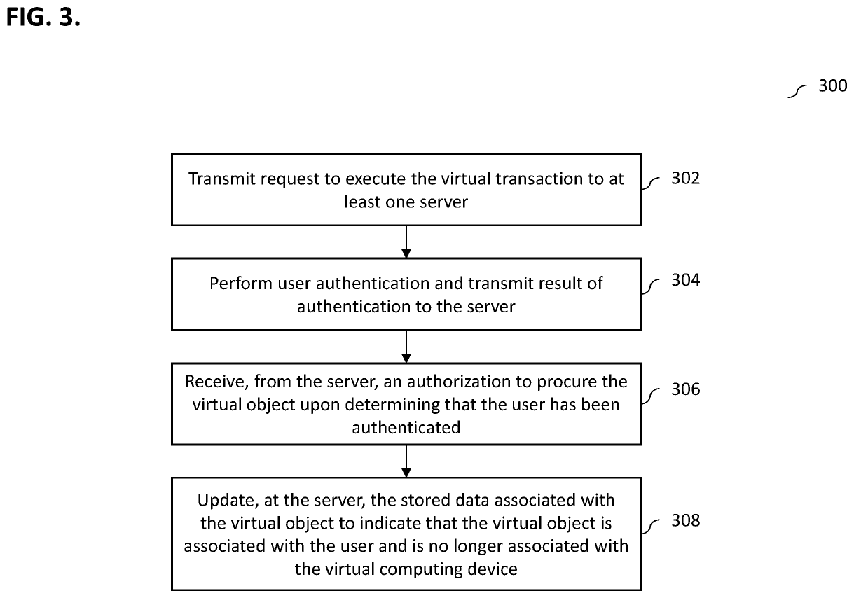

At 206, the server 108 (and/or device 106) may be configured to determine whether a match between the received user authentication data and the stored user authentication data exists. If so, the server 108 (and/or device 106), may authenticate the user in the virtual computing system 104, at 208, and subsequently, execute the transaction requested by the user using the virtual computing device 106, at 210. For example, as discussed above, the transaction may involve procuring one or more objects 107, as shown in FIG. 3.

However, if, at 206, the server 108 (and/or device 106) determines that a match between the received user authentication data and the stored user authentication data does not exist, the server 108 (and/or device 106) may prevent execution of the virtual transaction using the virtual computing device 106, at 212.

FIG. 3 illustrates an exemplary process 300 for procuring one or more objects 107 (as shown in FIG. 1), according to some implementations of the current subject matter. The process 300 may be executed by the virtual computing system 104, and in particular, virtual computing device 106.

At 302, the virtual computing system 104 (e.g., in particular, the virtual computing device 106) may be configured to receive the user's selection of a particular object 107 for procurement. The virtual computing system 104 may be configured to transmit the received request to the engine (e.g., server) 108, which may be communicatively coupled to the virtual computing system 104. The server 108 may be configured to store data associated with the object 107 that has been selected and/or identified by the user. The selected object 107 may be configured to be identified with the virtual computing device 106, as shown in FIG. 1.

At 304, the virtual computing system 104 may be configured to execute authentication of the user (as discussed above). The result of the authentication may be transmitted to the server 108 and may include a determination whether the user has been authenticated. If the user has been authenticated, the transaction relating to the procurement of the selected object 107 may proceed forward.

At 306, the server 108 may be configured to transmit to the virtual computing system 104 an authorization to procure the selected object 107. Once the virtual computing system 104 receives the authorization (which may indicate that the user has been authenticated), the virtual computing system 104 may be configured to allow procurement of the object 107 by the user, which may include accessing user's digital wallet to obtain payment for the object 107. Further, the system 104 may be configured to update a status of and/or server-stored data associated with the procured object on the server 108, at 308. The updated data may indicate that the procured object is now associated with the user and is no longer associated with the virtual computing device 106.

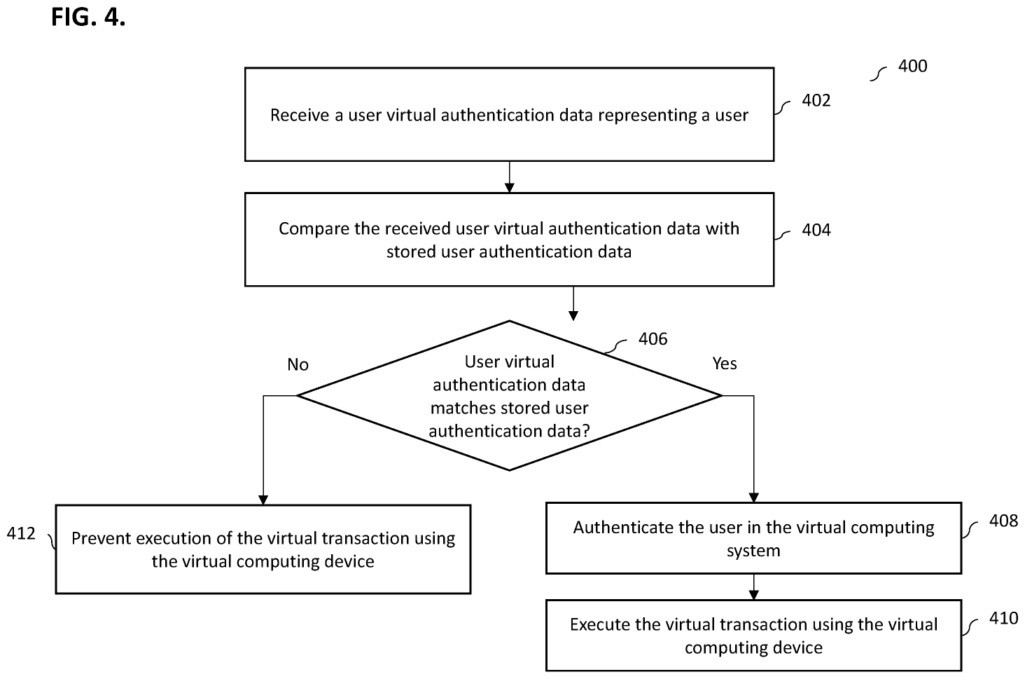

FIG. 4 illustrates another exemplary process 400 for execution of a transaction in the virtual computing environment 100 shown in FIG. 1, according to some implementations of the current subject matter. The process 400 may be used to by the user of the user device 102 to obtain and/or procure one or more objects (e.g., virtual and/or real objects) 107 that may be associated with the virtual computing device 106.

At 402, the virtual computing device 106 may be configured to receive the user's virtual authentication data that may be configured to represent the user of the user device 102 (e.g., VR/AR/XR glasses, devices, etc., sensory devices, etc.). As discussed above, the user may be configured to use the user device 102 to communicate with the virtual computing system 104 that may include the virtual computing device 106. In particular, the user device 102 may be configured to transmit a request to execute a virtual transaction associated with at least one object 107 in the virtual computing system, where, as shown in FIG. 1, the object 107 may be associated with the device 106. The user virtual authentication data may be generated by the user device 102 and transmitted to the virtual computing system 104.

The virtual authentication data may be generated by the user device 102 based on at least one user's personal identification data, such as, for instance, data associated with the user (e.g., name, address, etc.), data generated by the user device 102 based on the data associated with the user (e.g., encrypted file containing user's name, address, username, password, etc.), data generated by the user device 102 based on at least one action performed by the user and/or data generated by the user device 102 based on at least one action performed by the user device 102, and/or any other data. The data provided by the user device 102 to the virtual computing device 106 may include data representing at least one gesture performed by the user, at least one movement performed by the user, at least one biometric data associated with the user, and/or any other type of data.

At 404, the received user virtual authentication data may be compared with stored user authentication data, which may be stored in the storage location 110 that may be communicatively coupled to the virtual computing system 104. The stored user authentication data may have been previously generated and stored for future use. Alternatively, or in addition, the user may be asked by the virtual computing system 104 to provide various information, credentials, tokens, etc. prior to being provided access to the virtual computing system 104 and/or any of its devices 106 and/or objects 107. This information may be used to generate and store user authentication data, which may be used during execution of transactions by the user with device(s) 106.

At 406, a determination may be made whether there exists a match between the received user virtual authentication data and the stored user authentication data. If a match exists, the user may be authenticated in the virtual computing system 104 and the virtual transaction, which has been requested by the user, may be executed by the virtual computing device 106, at 410. Once the user has been authenticated, the virtual computing system 104 may transmit a request to execute the virtual transaction to the server 108, which may store data associated with the object that the user desires to procure. The object may be associated and/or identified with the virtual computing device 106. The system 104 may then transmit a result of the authentication (e.g., including an indication of whether or not the user has been authenticated) to the server 108. The server 108 may then transmit an authorization to procure the object upon an indication that the user has been authenticated. Once the object has been procured (and/or paid for from user's digital walled), the server may update the stored data associated with the procured object to indicate that the object is now associated with the user and not with the virtual computing device 106.

If, at 406, the match does not exist, execution of the virtual transaction may be prevented. In this case, the virtual computing device 106 may generate and transmit an indication to the user device 102 that authentication of the user has failed and transaction has been aborted.

In some implementations, as discussed above, the virtual transactions that may be executed using the process 400 may include a virtual purchase transaction, a virtual gaming transaction, and/or any other types of transactions, where the device 106 may, for example, be a virtual point-of-sale terminal, a virtual gaming terminal, etc.

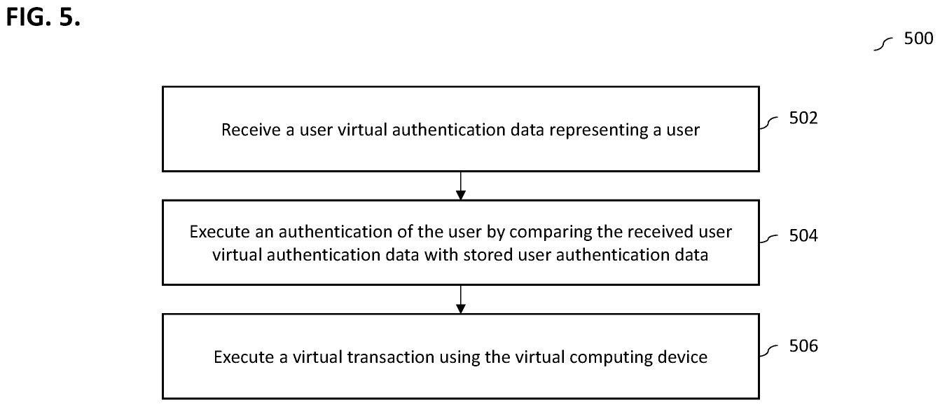

FIG. 5 illustrates another exemplary process 500 for executing a transaction in a virtual computing environment (e.g., environment 100 shown in FIG. 1), according to some implementations of the current subject matter. The process 500 may, likewise, be executed using one or more components of the environment 100 shown in FIG. 1.

At 502, a user virtual authentication data may be received by the virtual computing device 106 shown in FIG. 1. The user may use the user device 102 to communicate with the virtual computing device 106 to transmit a request to execute a virtual transaction associated with at least one virtual object 107 in the virtual computing system 104. The user's device 102 may be configured to generate the virtual authentication data and transmit it to the virtual computing system.

At 504, an authentication of the user may be executed by comparing the received user virtual authentication data with at least one stored user authentication data, which may be stored in the storage location 110. Based on the execution of the authentication, the virtual transaction may be executed using the virtual computing device 106. To execute such transaction, the virtual computing system 104 may be configured to transmit a request to execute the virtual transaction to the server 108 that may store data associated with the virtual object, which may be associated and/or identified with the virtual computing device 106. The virtual computing system 104 may then receive, from the server 108, an authorization to procure the virtual object upon determining that the user has been authenticated.

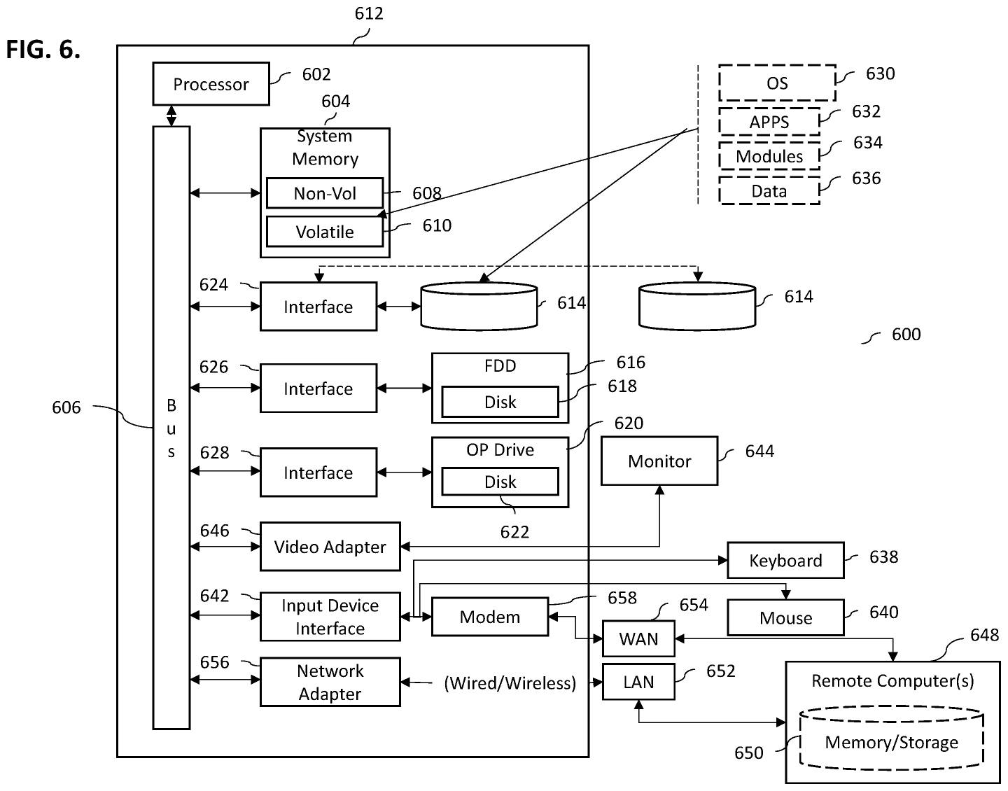

FIG. 6 illustrates an embodiment of an exemplary computer architecture 600 suitable for implementing various embodiments as previously described. In some implementations, the computer architecture 600 may include or be implemented as part of environment 100 shown in FIG. 1. In some implementations, the computing system 600 may be representative, for example, of the components 102-110 shown in FIG. 1. As can be understood, these implementations are not limited in this context. More generally, the computing architecture 600 may be configured to implement all logic, applications, systems, methods, apparatuses, and functionality described herein with reference to FIGS. 1-5 above.

As used in this application, the terms “system” and “component” are intended to refer to a computer-related entity, either hardware, a combination of hardware and software, software, or software in execution, examples of which are provided by the exemplary computing computer architecture 600. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computer architecture 600 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing computer architecture 600.

As shown in FIG. 6, the computer architecture 600 includes a computer 612 comprising a processor 602, a system memory 604 and a system bus 606. The processor 602 can be any of various commercially available processors. The computer 612 may be representative of at least one of the components 102-110 shown in FIG. 1.

The system bus 606 provides an interface for system components including, but not limited to, the system memory 604 to the processor 602. The system bus 606 can be any of several types of bus structure that may further interconnect to a memory bus (with or without a memory controller), a peripheral bus, and a local bus using any of a variety of commercially available bus architectures. Interface adapters may connect to the system bus 606 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computer architecture 600 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 604 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 6, the system memory 604 can include non-volatile 608 and/or volatile 610. A basic input/output system (BIOS) can be stored in the non-volatile 608.

The computer 612 may include various types of computer-readable storage media in the form of one or more lower speed memory units, including an internal (or external) hard disk drive 614, a magnetic disk drive 616 to read from or write to a removable magnetic disk 618, and an optical disk drive 620 to read from or write to a removable optical disk 622 (e.g., a CD-ROM or DVD). The hard disk drive 614, magnetic disk drive 616 and optical disk drive 620 can be connected to the system bus 606 by an HDD interface 624, and FDD interface 626 and an optical disk drive interface 628, respectively. The HDD interface 624 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 608, and volatile 610, including an operating system 630, one or more applications 632, other program modules 634, and program data 636. In one embodiment, the one or more applications 632, other program modules 634, and program data 636 can include, for example, the various applications and/or components of the environment 100.

A user can enter commands and information into the computer 612 through one or more wire/wireless input devices, for example, a keyboard 638 and a pointing device, such as a mouse 640. Other input devices may include microphones, infra-red (IR) remote controls, radio-frequency (RF) remote controls, game pads, stylus pens, card readers, dongles, fingerprint readers, gloves, graphics tablets, joysticks, keyboards, retina readers, touch screens (e.g., capacitive, resistive, etc.), trackballs, track pads, sensors, styluses, and the like. These and other input devices are often connected to the processor 602 through an input device interface 642 that is coupled to the system bus 606 but can be connected by other interfaces such as a parallel port, IEEE 1394 serial port, a game port, a USB port, an IR interface, and so forth.

A monitor 644 or other type of display device is also connected to the system bus 606 via an interface, such as a video adapter 646. The monitor 644 may be internal or external to the computer 612. In addition to the monitor 644, a computer typically includes other peripheral output devices, such as speakers, printers, and so forth.

The computer 612 may operate in a networked environment using logical connections via wire and/or wireless communications to one or more remote computers, such as a remote computer(s) 648. The remote computer(s) 648 can be a workstation, a server computer, a router, a personal computer, portable computer, microprocessor-based entertainment appliance, a peer device or other common network node, and typically includes many or all the elements described relative to the computer 612, although, for purposes of brevity, only a memory and/or storage device 650 is illustrated. The logical connections depicted include wire/wireless connectivity to a local area network 652 and/or larger networks, for example, a wide area network 654. Such LAN and WAN networking environments are commonplace in offices and companies, and facilitate enterprise-wide computer networks, such as intranets, all of which may connect to a global communications network, for example, the Internet.

When used in a local area network 652 networking environment, the computer 612 is connected to the local area network 652 through a wire and/or wireless communication network interface or network adapter 656. The network adapter 656 can facilitate wire and/or wireless communications to the local area network 652, which may also include a wireless access point disposed thereon for communicating with the wireless functionality of the network adapter 656.

When used in a wide area network 654 networking environment, the computer 612 can include a modem 658, or is connected to a communications server on the wide area network 654 or has other means for establishing communications over the wide area network 654, such as by way of the Internet. The modem 658, which can be internal or external and a wire and/or wireless device, connects to the system bus 606 via the input device interface 642. In a networked environment, program modules depicted relative to the computer 612, or portions thereof, can be stored in the remote memory and/or storage device 650. It will be appreciated that the network connections shown are exemplary and other means of establishing a communications link between the computers can be used.

The computer 612 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, ac, ax, etc.) to provide secure, reliable, fast wireless connectivity. A Wi-Fi network can be used to connect computers to each other, to the Internet, and to wire networks (which use IEEE 802.3-related media and functions).

The various elements of the devices as previously described with reference to FIGS. 1-5 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores”, may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

What is claimed:

1. A computer-implemented method, comprising:
receiving, using at least one processor, a request to execute a virtual transaction with a virtual computing device communicating in a virtual computing system, the virtual transaction being requested by a user using a user device communicating with the virtual computing system; and
authenticating, using the at least one processor, in response to receiving the request to execute the virtual transaction, the user in the virtual computing system, the authenticating including
receiving, by the virtual computing device, in response to a request from the virtual computing system, a user virtual authentication data representing the user, the user virtual authentication data being generated by the user device and transmitted to the virtual computing system;
comparing the received user virtual authentication data with at least one stored user authentication data, the at least one stored user authentication data being stored in a storage location communicatively coupled to the virtual computing system;
upon determining a match between the received user virtual authentication data and the at least one stored user authentication data, authenticating the user in the virtual computing system and executing the virtual transaction using the virtual computing device; and
upon failing to determine a match between the received user virtual authentication data and the at least one stored user authentication data, preventing execution of the virtual transaction using the virtual computing device.

2. The method according to claim 1, wherein the virtual computing device includes at least one of the following: a virtual point-of-sale terminal, a virtual gaming terminal, and any combination thereof.

3. The method according to claim 1, wherein the virtual transaction includes at least one of the following: a virtual purchase transaction, a virtual gaming transaction, and any combination thereof.

4. The method according to claim 1, wherein the virtual authentication data is generated by the user device based on at least one personal identification data, the at least one personal identification data includes at least one of the following: data associated with the user, data generated by the user device based on the data associated with the user, data generated by the user device based on at least one action performed by the user, data generated by the user device based on at least one action performed by the user device, and any combination thereof.

5. The method according to claim 4, wherein the at least one personal identification data includes at least one of the following: at least one gesture performed by the user, at least one movement performed by the user, at least one biometric data associated with the user, and any combination thereof.

6. The method according to claim 1, wherein the virtual transaction is associated with at least one virtual object existing in the virtual computing system.

7. The method according to claim 6, wherein the request to execute the virtual transaction includes procuring the at least one virtual object.

8. The method according to claim 7, wherein the procuring the at least one virtual object includes
transmitting, by the virtual computing system, the request to execute the virtual transaction to at least one server communicatively coupled to the virtual computing system, the at least one server storing data associated with the at least one virtual object and being identified with the at least one virtual computing device;
performing, by the virtual computing system, the authenticating of the user, and transmitting a result of the authenticating to the at least one server, the result including a determination whether the user has been authenticated; and
receiving, by the virtual computing system, from the at least one server, an authorization to procure the at least one virtual object upon determining that the user has been authenticated;
wherein, upon procuring of the at least one virtual object, updating, at the at least one server, the stored data associated with the at least one virtual object to indicate that the at least one virtual object is associated with the user and is no longer associated with the at least one virtual computing device.

9. A system, comprising:
at least one processor; and
at least one non-transitory storage media storing instructions, that when executed by the at least one processor, cause the at least one processor to perform operations including
receiving, by a virtual computing device, a user virtual authentication data representing a user, the user using a user device, communicating with a virtual computing system including the virtual computing device, to transmit a request to execute a virtual transaction associated with at least one virtual object in the virtual computing system, the user virtual authentication data being generated by the user device and transmitted to the virtual computing system;
comparing the received user virtual authentication data with at least one stored user authentication data, the at least one stored user authentication data being stored in a storage location communicatively coupled to the virtual computing system;
upon determining a match between the received user virtual authentication data and the at least one stored user authentication data, authenticating the user in the virtual computing system and executing the virtual transaction using the virtual computing device; and
upon failing to determine a match between the received user virtual authentication data and the at least one stored user authentication data, preventing execution of the virtual transaction using the virtual computing device.

10. The system according to claim 9, wherein
the virtual computing device includes at least one of the following: a virtual point-of-sale terminal, a virtual gaming terminal, and any combination thereof;
the virtual transaction includes at least one of the following: a virtual purchase transaction, a virtual gaming transaction, and any combination thereof.

11. The system according to claim 9, wherein the virtual authentication data is generated by the user device based on at least one personal identification data, the at least one personal identification data includes at least one of the following: data associated with the user, data generated by the user device based on the data associated with the user, data generated by the user device based on at least one action performed by the user, data generated by the user device based on at least one action performed by the user device, and any combination thereof.

12. The system according to claim 11, wherein the at least one personal identification data includes at least one of the following: at least one gesture performed by the user, at least one movement performed by the user, at least one biometric data associated with the user, and any combination thereof.

13. The system according to claim 9, wherein the operations further comprise procuring the at least one virtual object, the procuring including
transmitting, by the virtual computing system, a request to execute the virtual transaction to at least one server communicatively coupled to the virtual computing system, the at least one server storing data associated with the at least one virtual object and being identified with the at least one virtual computing device;
performing, by the virtual computing system, the authenticating of the user, and transmitting a result of the authenticating to the at least one server, the result including a determination whether the user has been authenticated; and
receiving, by the virtual computing system, from the at least one server, an authorization to procure the at least one virtual object upon determining that the user has been authenticated.

14. The system according to claim 13, wherein the operations further comprise
updating, at the at least one server, the stored data associated with the at least one virtual object to indicate that the at least one virtual object is associated with the user and is no longer associated with the at least one virtual computing device.

15. A computer program product comprising a non-transitory machine-readable medium storing instructions that, when executed by at least one programmable processor, cause the at least one programmable processor to perform operations comprising:
receiving, by a virtual computing device, a user virtual authentication data representing a user, the user using a user device, communicating with a virtual computing system including the virtual computing device, to transmit a request to execute a virtual transaction associated with at least one virtual object in the virtual computing system, the user virtual authentication data being generated by the user device and transmitted to the virtual computing system;
executing an authentication of the user by comparing the received user virtual authentication data with at least one stored user authentication data, the at least one stored user authentication data being stored in a storage location communicatively coupled to the virtual computing system;
executing, based on the executing of the authentication, the virtual transaction using the virtual computing device, the executing of the virtual transaction including
transmitting, by the virtual computing system, a request to execute the virtual transaction to at least one server communicatively coupled to the virtual computing system, the at least one server storing data associated with the at least one virtual object and being identified with the at least one virtual computing device;
receiving, by the virtual computing system, from the at least one server, an authorization to procure the at least one virtual object upon determining that the user has been authenticated.

16. The computer program product according to claim 15, wherein the operations further comprise
updating, at the at least one server, the stored data associated with the at least one virtual object to indicate that the at least one virtual object is associated with the user and is no longer associated with the at least one virtual computing device.

17. The computer program product according to claim 15, wherein the virtual computing device includes at least one of the following: a virtual point-of-sale terminal, a virtual gaming terminal, and any combination thereof.

18. The computer program product according to claim 15, wherein the virtual transaction includes at least one of the following: a virtual purchase transaction, a virtual gaming transaction, and any combination thereof.

19. The computer program product according to claim 15, wherein the virtual authentication data is generated by the user device based on at least one personal identification data, the at least one personal identification data includes at least one of the following: data associated with the user, data generated by the user device based on the data associated with the user, data generated by the user device based on at least one action performed by the user, data generated by the user device based on at least one action performed by the user device, and any combination thereof.

20. The computer program product according to claim 19, wherein the at least one personal identification data includes at least one of the following: at least one gesture performed by the user, at least one movement performed by the user, at least one biometric data associated with the user, and any combination thereof.
